(19) United States
(12) Patent Application Publication
(10) Pub. No.: US 2007/0014185 A1
(43) Pub. Date: Jan. 18, 2007

(54) Blending system

(76) Inventors: Jean-Michel Diosse, Clamart Cedex (FR); Franck Vermet, Clamart Cedex (FR)

Correspondence Address: Thomas O Mitchell;Schlumberger Technology Corporation, 110 Schlumberger Drive MD#1, Sugar Land, TX, 77478, US

(21) Appl. No.: 10/565,536

(22) PCT Filed: Jul. 22, 2004
(86) PCT No.: PCT/EP04/08278

§ 371 Date: Jan. 19, 2006

(30) Foreign Application Priority Data
Jul. 24, 2003 (EP) 0391838.5

(51) Int. Cl. B28C 7/04; B01F 15/04; B01F 5/24

(52) U.S. Cl. 366/9; 366/183.1; 366/341

(57) ABSTRACT

A method, for obtaining a mix of a plurality of matters in a fluid state comprises providing for a first matter of the plurality of matters a first flow of matter. For each matter of the plurality of matters distinct from the first matter, a flow of matter is provided at a determined flow rate. The method further comprises gathering each flow of matter at an inlet of a mixer, the mixer continuously producing at an outlet a substantially homogeneous flow of matter corresponding to the mix.

### FIELD OF THE INVENTION

The present invention relates to a system for blending materials. In particular it relates to a system for blending materials that go to make up a cement slurry such as may be used in a well cementing operation.

### BACKGROUND ART

Obtaining fluid mixtures often involves blending a plurality of materials according to a predetermined mixture recipe. The materials may, for example, be liquids, gels, or solids in particulate and/or powder form. The mixture recipe typically indicates the ratio of each product. Hence, to obtain any final quantity of the mixture it is necessary to determine for each product a respective required quantity.

The blending is often a sequential process. At first the required quantity for each of the materials is measured, e.g., by weight or by volume. The products are then poured into a mixing device, either one after the other or together, where they are mixed. This may for example be achieved mechanically, for example by stirring the materials with rotating blades. When one or more of the materials are in a particulate or powder form, the blending may comprise one or more weighing and mechanical mixing steps. Blending as a sequential process is commonly performed for preparing oilfield cement blends. An example of preparation of cement blends is illustrated by a flowchart in FIG. 1. For each product, the mass of the product necessary for forming a batch is determined 11 corresponding to the ratio of the product indicated in the mix recipe. Then for each product, the predetermined mass is provided by weighing out the appropriate amount of product 12. Finally, the weighed amounts are introduced 13 into a mechanical mixer. The mechanical mixer may be a screw rotating inside of a cylinder or a rotary drum. The products are mechanically mixed 14, forming a resulting cement blend that is eventually collected 15.

This sequential method is ill-suited if the individual volume (or mass) fractions of the different components of the mixture are dramatically different. This is the case for instance with cement blend made essentially of cement with other solid additives in relatively minor amounts.

### SUMMARY OF INVENTION

In a first aspect, the present invention proposes to blend multiple solid components according to a predefined ratio including providing for each component a fluidized flow at a predetermined flow rate corresponding to the ratio of said component in the mixture and conveying each flow to the inlet of a static mixer exclusively by gravity, the mixer continuously producing at an outlet a flow of the mixture.

This method may further include dispersing the individual flows inside the mixer for instance by providing at least one static obstacle in the flows.

According to a preferred embodiment, the flow rate of a selected component of the mixture is monitored and the flow rate of the other components is adjusted in real-time base on that effective monitored flow rate.

In a second aspect, the invention provides an apparatus for preparing a mixture of solid components in a predetermined ratio comprising reservoir means for each individual components associated with individual flow generators, means associated to each flow generator for adjusting said individual generated flow rate based on the ratio of each component, a static mixer having an inlet into which all individual flows are conveyed exclusively by gravity, said mixer continuously producing at an outlet a flow of mixture

The flow rates are preferably adjusted using knife gate valves placed right along the bottom of the individual container. In yet another preferred embodiment, each reservoir includes a grid extending from the lower portion of its lateral walls to its opening, said grid substantial impermeable to the component but permeable to air, and means for introducing air into the gap between the hopper bottom and the grid.

The apparatus is preferably equipped with sensors to measure the effective flow rate of a selected element and a controlled actuating system for controlling the valves directing the flows of the other components based upon said effective flow rate.

Other aspects and advantages of the invention will be apparent from the following description and the appended claims.

### BRIEF DESCRIPTION OF DRAWINGS

The invention will now be described in greater detail with reference to the accompanying drawings, in which:

FIG. 1 is a flowchart illustrating an example of a prior art cement blending process;

FIG. 2 is a flowchart illustrating an example embodiment of the present invention;

FIG. 3 is a schematic illustration of the apparatus according to the present invention;

FIG. 4 is a schematic illustration of the fluidizing means;

FIG. 5 illustrates an example of a mixer according to the invention;

FIG. 6 illustrates an example of a control system;

FIG. 7 is an example flowchart illustrating a control system.

FIG. 8 is an example flowchart illustrating another control system.

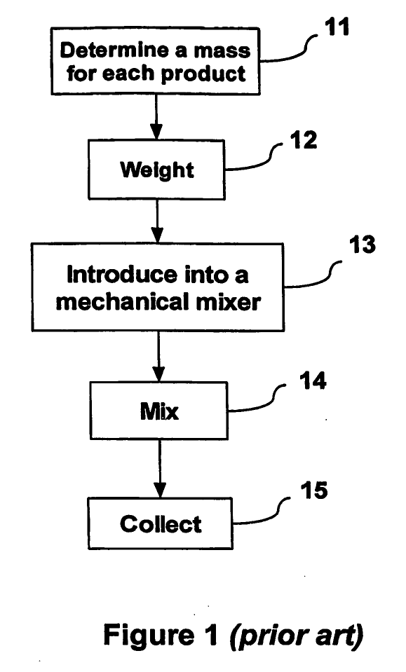

### DETAILED DESCRIPTION

The same references will be used to reference the same elements in the Figures throughout the description.

The cement blending known from the prior art is a sequential process, during which each product is weighed before being poured into the mixing device. When such cement blending is repeated to produce several batches, the batches may not be perfectly identical. For this reason, a production quality for cement blended in the sequential process may vary from one batch to another.

The present invention allows obtaining a substantially constant production quality when blending cement. The present invention may produce identical batches, or a continuous flow of blend for any quantity of cement mixture.

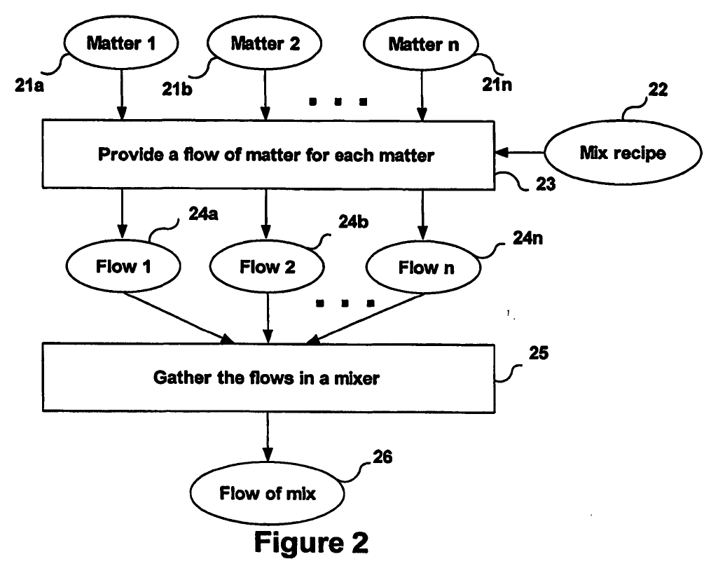

FIG. 2 provides a flowchart illustrating an example of the present invention. A first flow of cement 21ₐ is provided. For each other material (21_{b}, . . . 21ₙ), for example low density paniculate materials such as micro-spheres, fine particulate materials such as micro-silica, etc., a separate flow 23 is provided at a predetermined flow rate. The flow rate of each component of the mixture (24ₐ, 24_{b}, . . . 24ₙ) corresponds to the ratio of the components in the mixture recipe 22. For example, the mixture recipe 22 may indicate that for preparing 600 kg of the cement blend, it is necessary to mix 200 kg of cement with 400 kg of a second product. According to the present example, the flow of the cement and a flow of the second product are provided, the flow rate of the second product being twice as high as the flow rate of the cement. In this example, the flow rate of each component (24ₐ, 24_{b}, . . . 24ₙ) is a mass flow rate. For a volume flow rate, it is necessary to take into consideration a density of each matter when calculating the rate of the flow.

The flows of the various components (24ₐ, 24_{b}, . . . 24ₙ) are gathered in a mixer 25 where they are continuously blended so that the mixer continuously produces at an outlet a substantially homogeneous flow. Since the flow rates of each component respectively have a determined value corresponding to the ratio of the component in the mixture recipe, the substantially homogeneous flow corresponds to the mixture 26 of the recipe 22.

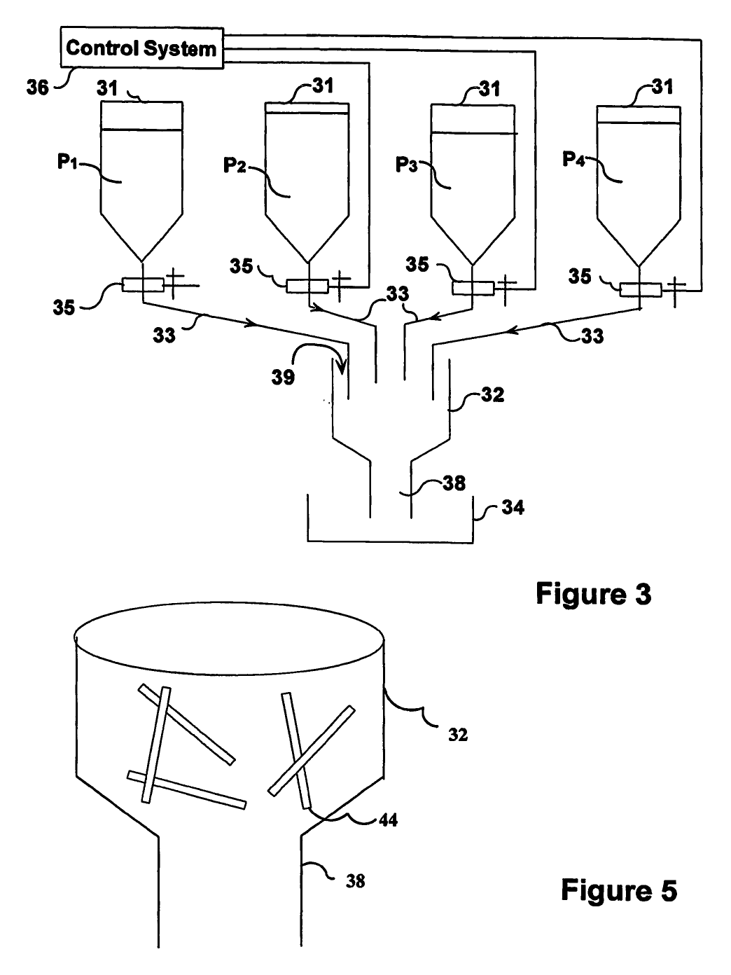

FIG. 3 shows a schematic illustration of an example apparatus according to the present invention. In this embodiment, four products (P₁, P₂, P₃, P₄) are blended so as to prepare the cement blend. Each product is in a powder form and is stored in a hopper 31. For each flow, the determined flow rate is calculated according to the ratio of the product indicated in the mixture recipe. For each product, the flow is provided at the predetermined flow rate; the flow rate of each product is controlled using an adjustable valve 35.

In this embodiment, each of the four products is conveyed from the hopper to an inlet of the mixer 32 by gravity respectively through a pipe 33. Each flow rate may be individually adjusted depending on an opening of the adjustable valve 35. The opening may be controlled manually, or automatically, using a control system 36. The control system 36 in this embodiment calculates for each product the flow rate corresponding to the ratio of the product in the mixture recipe and controls the opening of each adjustable valve.

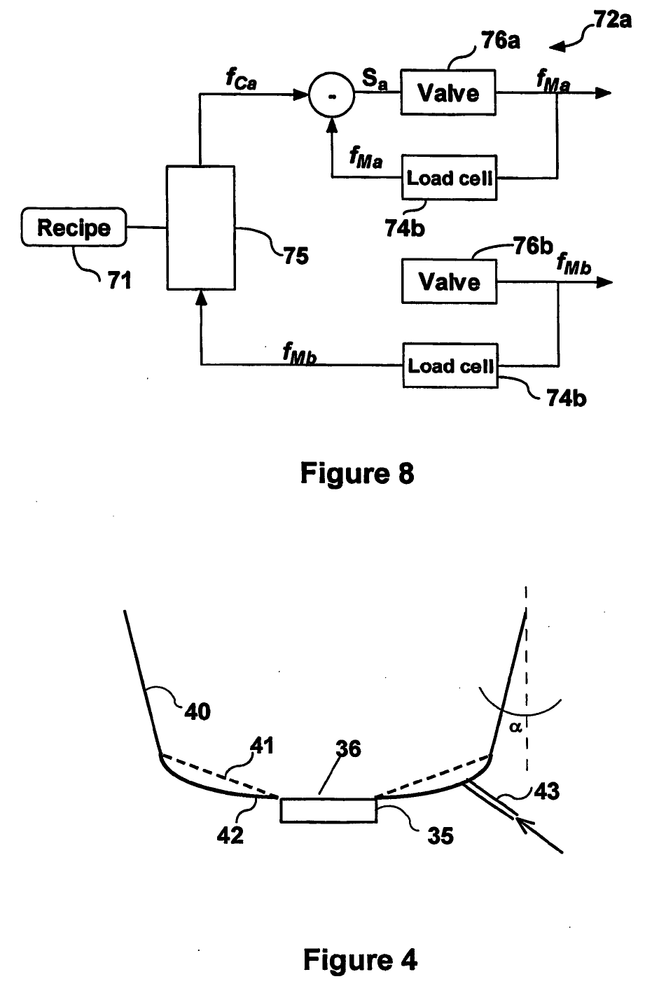

A detail of the bottom of each hopper 31 is illustrated FIG. 4. To obtain a regular flow by pure gravity, the lateral walls 40 of the hoppers are preferably substantially vertical, for instance making an angle α to the vertical not greater than 23°. A grid 41 is located between the lower extremity of the vertical walls 40 and the opening 37 in the bottom 42 of the hopper that faces the valve 35. Note that in practice, the lateral walls 40 and the bottom 42 are preferably two independent parts maintained together with an impermeable joint. The grid is typically made of a perforated plaque covered by a mesh so that it is substantially impermeable to the powder stored in the hopper 31 but permeable to air. Air is injected between the grid 41 and the bottom 42 through an injector 43 that creates a continuous air circular flow. Such a device ensures that the flow rate of component is then solely dependent on the surface area offered for the powder to flow, said surface area defined by the valve 35, preferably a knife gate valve. Best results were obtained with a through-conduit bi-directional wafer valve due to the opening shape that prevents powder bridging at the outlet.

Since the flow depends only of the opening area and not of the height of component in the hoppers (at least in a first approximation), the hoppers can be refilled at any time, including while blending, thereby avoiding any interruption of the flows of matters. Continuous feeding may also be provided for all or some of the hoppers.

As the products are conveyed by gravity to the inlet 39 of the mixer 32, particles of each product gain sufficient velocity for generating a chaotic flow in the mixer that is enough to promote a complete blending. Dispersing means may also be provided (though not compulsory) if required, such the ones illustrated FIG. 5 and essentially made of randomly located rods 44 at the dispersing means, without requiring any movement of the dispersing means. In this embodiment, the mixer has a main body that is funnel-shaped in which rods 44 form a plurality of static obstacles mounted inside the mixer. The flows of products are dispersed as their particles collide with the static obstacles; generate chaos in the flows and scattering of matters. The position of the rods may be adjusted if necessary. The gathering and the subsequent dispersion of the flows of matters provide a mixing of the products to obtain the cement blend. The products are blended without any movement of the mixer 32, and more precisely without any movement of the static obstacles mounted therein.

Once the products are blended, the resulting mix is evacuated. In this embodiment, the mixer includes an outlet 38 through which the mix continuously pours away and is collected in a vessel 34. The vessel 34 contains the batch of blended cement. Once filled, the vessel 34 may be transferred to a well site for mixing with water and use. The blend may be provided at a temporary storage location prior to such use.

Alternatively, the resulting mix may be directly blended with water, thus forming a slurry. The blending of the resulting mix with the water may be performed with a Solid Fraction Monitoring system (see, for example, U.S. Pat. No. 6,491,421), or any other continuous or batch water and cement mixing system. The slurry may be directly pumped into an annulus of a well.

The process according to the invention is continuous as opposed to the sequential process from prior art. The batches that are delivered from the system have a constant quality: the production quality does not vary from one batch to the other and is substantially improved as compared to the batches obtained in the Prior Art. Moreover, as long as means is provided for taking the blend out of the blending unit, for instance through a band conveyor or a feed screw, the mixing process can occur without any interruption even for uploading the hopper since this operation can be done while the hopper are delivering products to the mixer. This results in very high throughput.

Additionally, such process does not require any mechanical action to provide the mixing of the products.

Where the mixer does not comprise any static obstacle, or any propulsion means, the main body is also preferably funnel-shaped to facilitate the gathering of the flows. The velocity of the particles is itself sufficient to create a chaotic dispersion when the flows are gathered. Outputs of the pipes may be close enough to each other so that the poured products merge at a same point, thus providing a mixing of the products. End portions of the pipes may have relative angulations so as to facilitate the gathering of the flows of matter and to disperse the particles. The dispersion and the gathering happen simultaneously in this embodiment.

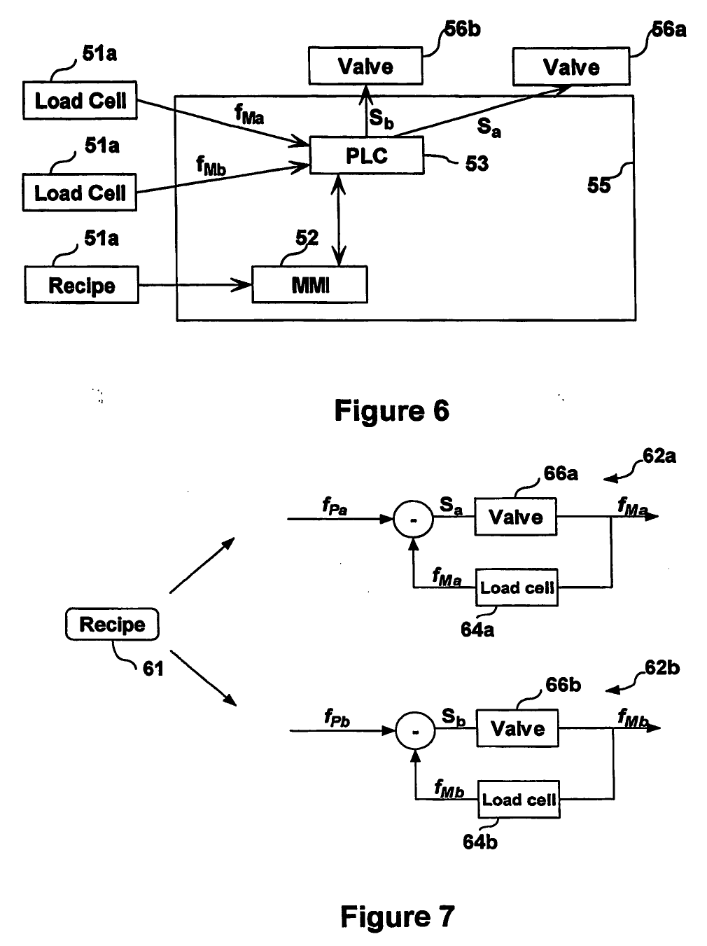

FIG. 6 provides a schematic illustration of one example embodiment of the control system, wherein two products are mixed. In this example, the control system 55 comprises a Man Machine Interface 52 communicating with a Programmable Logic Controller 53. The Man Machine Interface 52 allows an operator entering the mixture recipe 54, and to exchange orders. For each product, a predetermined flow rate is calculated from the ratio of the product in the mixture recipe.

The Programmable Logic Controller 53 regulates the flow rate for each product at the value of the predetermined flow rate. In this example, an effective flow rate of each product depends on an opening of a corresponding valve. The effective flow rate of each flow may be subject to small variations that are due to uncontrolled parameters. For example, if the matter of a determined product is not perfectly homogeneous, the effective mass flow rate of this product may vary despite the fact that the opening of the corresponding valve does not change. The Programmable Logic Controller 53 regulates the flow rate by controlling the opening of each valve (56a, 56b).

The effective flow rate for each product is monitored. For a product in a powder form, a sensor, e.g. a load cell (51 a, 51 b), may be used to provide an effective mass flow rate (f_{Ma}, f_{Mb}). The control system 55 receives a sensor signal from each load cell (51a, 51b). The valves (56a, 56b) are controlled by a command signal (Sₐ, S_{b}) output by the Programmable Logic Controller 53. To be noted that in the present case, the term “load cell” is used for referring to a weight sensor—not to a means for evaluating the total weight in a silo, as in traditional system where the first step of preparing a blend consists in measuring individually the weight of each ingredient.

FIG. 7 is a flowchart illustrating a function of the control system from FIG. 6. For each product, a loop (62a, 62b) is provided to maintain an effective mass flow rate around a value of a predetermined flow rate (fpₐ, fp_{b}) corresponding to a ratio of the product in a mixture recipe. The value of the predetermined flow rate (f_{Pa}, f_{pb}) is calculated for each product according to the mixture recipe (61) of the cement blend. A load cell (64a, 64b) of a determined product provides a sensor signal (f_{Ma}, f_{M}b) that is indicative of the value of the effective flow rate of the determined product. The value of the effective flow rate is then compared to the value of the predetermined flow rate (f_{Pa}, f_{pb}). The command signal (Sₐ, S_{b}) that controls the opening of the adjustable valve (66a, 66b) has a value that depends on the difference between the value of the effective flow rate and the value of the predetermined flow rate (fpₐ, fp_{b}). If the effective value of the flow rate is higher than the value of the predetermined flow rate (f_{Pa}, f_{pb}), the opening of the valve (66a, 66b) is decreased. If the effective value of the flow rate is smaller than the value of the predetermined flow rate (f_{Pa}, f_{pb}), the opening of the valve (66a, 66b) is increased. The flow rate of each product is thus maintained at a value corresponding substantially to the predetermined value (f_{Pa}, f_{Pb}).

FIG. 8 is a flowchart according to an alternative embodiment. A first adjustable valve 76b enables to provide a flow of cement. A first load cell 74b provides a sensor signal (f_{Mb}) that is indicative of a value of a effective flow rate of the cement. The flow of the cement is not controlled and the flow rate of a second product is monitored to a value that depends on the value of the effective flow rate of cement.

Calculating means 75 calculate a flow rate (f_{Ca}) for the second product according the value of the effective flow rate of cement and according to ratios of the components in the recipe 71. For example, the mix recipe 71 may indicate that for preparing 600 kg of the cement blend, it is necessary to mix 200 kg of cement with 400 kg of the second product. The cement effective flow rate is monitored. The calculated flow rate (f_{Ca}) is equal to twice the cement effective flow rate.

A loop 72a is provided to regulate the flow rate of the second product based on a value of the calculated flow rate (f_{ca}). The loop 72a comprises a second adjustable valve 76a and a second load cell 74a. The second load cell 74 a provides a sensor signal (f_{Ma}) that is indicative of a value of a effective flow rate of the second product. The value of the second effective flow rate is compared to the value of the calculated flow rate (fcₐ). A command signal (Sₐ) that controls the opening of the second adjustable valve 76a has a value that depends on the difference between the value of the second effective flow rate and the value of the calculated flow rate (f_{ca}). If the effective value of the second flow rate is higher than the value of the calculated flow rate (fcₐ), the opening of the second valve 76a is decreased. If the effective value of the second flow rate is smaller than the value of the calculated flow rate (fcₐ), the opening of the second valve 76a is increased. The flow rate of the second product is thus maintained at a value corresponding substantially to the calculated value (fcₐ). The flow rate of each component corresponds to the ratio of the matter in the mixture recipe 71.

The mixer of the invention is particularly suitable for preparing cement blend including for instance cement, silica sand and other solid components.

1. A method for obtaining a mixture constituted of solid components (21a, 21b, . . . 21n), in a predetermined ratio comprising providing for each component a fluidized flow (24a, 24b, . . . 24n) at a predetermined individual flow rate corresponding to the ratio of said component in the mixture; conveying each flow (24a, 24b, . . . 24n) to the inlet (39) of a static mixer (32) exclusively by gravity, the mixer continuously producing at an outlet (38) a flow of the mixture (26).

2. The method of claim 1, further comprising: dispersing the flows inside the mixer.

3. The method of claim 2, wherein the dispersing comprises causing the flows to pass at least one static obstacle inserted in the flows.

4. The method according to any one of claims 1 to 3, further comprising monitoring an effective flow rate of one selected component of the mixture; and adjusting in real time the individual flow rates of each other components based on said effective flow rate.

5. The method according to any one of claims 1 to 4, wherein the step of providing a fluidized flow includes injecting air the container storing the into a component stored in a container so as to render the component flowable.

6. The method according to any preceding claim, wherein said mixture includes a cement and further comprising blending the mixture with water to form a slurry; pumping the slurry into an annulus of a well.

7. An apparatus for preparing a mixture of solid components in a predetermined ratio comprising reservoir means (31) for each individual components associated with individual flow generators (35), means associated to each flow generator (35) for adjusting said individual generated flow rate based on the ratio of each component, a static mixer (39) having an inlet (39) into which all individual flows are conveyed exclusively by gravity, said mixer (39) continuously producing at an outlet (38) a flow of mixture.

8. The apparatus of claim 7, wherein said means associated to each flow generator (35) for adjusting said individual generated flow rate based include knife gate valves.

9. The apparatus of claim 7 or claim 8, wherein said reservoir means (31) is a hopper including lateral walls and a bottom with an opening, said hopper further comprising a grid extending from the lower portion of the lateral walls to the opening, and means for introducing air into the gap between the hopper bottom and the grid; said grid permeable to air but not to the component stored in the hopper.

10. The apparatus of claim 9, wherein the vertical walls of the hopper form an angle to the vertical ranging from 0 to 23°.

11. The apparatus according to claim 7, wherein the mixer (32) dispersing means (43) statically mounted inside the main body (41) so as to present an obstacle to the global flow entering the inlet (39).

12. The apparatus according to claim 7 or 8, further comprising: a Man Machine Interface (52) to input a mixture recipe; processing means to calculate for each component of the mixture the predetermined flow rate from a ratio of the components in the mixture recipe.

13. The apparatus according to claim 12, further comprising: a sensor system (64ₐ, 64_{b}) to measure a value of an effective flow rate of a selected component of the mixture, the sensor system producing a sensor signal indicative of the value of the effective flow rate of said component; an adjustable valve (66ₐ, 66_{b}), the effective flow rate of the component being adjusted depending on an opening of the adjustable valve; and wherein the adjustable valve and the sensor define a loop (62ₐ, 62_{b}), and the flow rate of the component being regulated to the predetermined flow rate using the sensor signal.
